(19) United States
(12) Patent Application Publication
(10) Pub. No.: US 2007/0050298 A1
(43) Pub. Date: Mar. 1, 2007

(54) Pay-per-view payment system and method

(75) Inventor: Tal Givoly, Cupertino, CA (US)

Correspondence Address: Zilka-Kotab, PC, P.O. BOX 721120, SAN JOSE, CA, 95172-1120, US

(73) Assignee: AMDOCS SOFTWARE SYSTEMS LIMITED, Dublin (IE)

(21) Appl. No.: 11/215,382

(22) Filed: Aug. 30, 2005

(51) Int. Cl. H04L 9/00

(52) U.S. Cl. 705/52

(57) ABSTRACT

A system, method and computer program product are provided for commercial-based payment for pay-per-view movies. Initially, a plurality of movies is displayed, utilizing an output device. Then, utilizing an input device, selection of at least one of the movies is received. In conjunction with the present technique, it is determined whether commercial-based payment is applicable. If it is determined that the commercial-based payment is applicable, a commercial is delivered, utilizing the output device. After delivering the commercial, the selected at least one movie is allowed to be viewed, utilizing the output device.

### FIELD OF THE INVENTION

The present invention relates to pay-per-view systems, and more particularly, to pay-per-view payment systems.

### BACKGROUND

A goal of many media distribution systems has been to provide users media (e.g. movies, television, sports, news broadcasts, etc.). For example, Video-On-Demand (VoD) systems enable a user to receive video service upon demand. In the case of VoD services, a user of a service is allowed to select what he/she wishes to view and is then able, ideally, to view the requested video at a time of the user's choosing.

Before the user is allowed viewing of a selected video service, however, payment is typically required. This is traditionally carried out by receiving a “payment” option after the desired video service is selected. In response to such payment option, a user is typically billed (i.e. a charge is applied to his/her account, etc.), and the user is sent a charge for the particular video service. After payment is complete, the video service is commenced.

Unfortunately, due to technical limitations associated with current networks underlying VoD systems which exist at the time of filing of the present patent application, payment for desired video services is typically limited to the scenario set forth above. For example, due to an inability for unfettered interactivity between the user and a back-end system, the selection of the aforementioned payment option is conventionally received and stored in a client device (e.g. set-top box, etc.), and a separate inquiry is required to access such payment information. In some systems, such separate inquiry is still carried out by a telecommunication network (e.g. phone line, etc.) that is separate from a broadband network (e.g. satellite, etc.) over which the video service is actually delivered.

Unfortunately, this typical framework severely limits the ways in which a user may pay for video services. There is thus a need for overcoming these and/or other problems associated with the prior art.

### SUMMARY

A system, method and computer program product are provided for commercial-based payment for pay-per-view movies. Initially, a plurality of movies is displayed, utilizing an output device. Then, utilizing an input device, selection of at least one of the movies is received. In conjunction with the present technique, it is determined whether commercial-based payment is applicable. If it is determined that the commercial-based payment is applicable, a commercial is delivered, utilizing the output device. In use, the selected at least one movie is allowed to be viewed, utilizing the output device.

In one embodiment, the movies may be displayed in a list. Further, the movies may be displayed in response to a search in a database initiated by a user. Still yet, the movies may be displayed in response to a request received at a web-site.

In another embodiment, it may be determined that the commercial-based payment is applicable by prompting a user to choose from a plurality of payment options. Such payment options may include a credit card payment option, a post-billing payment option, and a commercial-based payment option. To this end, the payment options may be displayed for selection.

In yet another embodiment, it may be determined that the commercial-based payment is applicable by querying a database reflecting preferences of a user. For example, at least one of the preferences of the user may indicate that the commercial-based payment is requested on an on-going basis.

In still yet another embodiment, a plurality of commercial options may be displayed, if it is determined that the commercial payment is applicable. In use, such commercial options may allow a user to select a number of commercials which are to be delivered. Optionally, a duration of the commercials may shorten as a function of the number of commercials which are to be delivered. As yet another option, the commercial options may allow a user to select among a plurality of commercials.

Optionally, the commercial may require interaction from the user. Still yet, the commercial may require feedback from the user. Thus, subsequent commercials may be delivered based on the interaction, or may be selected based on a user profile. As another option, the commercial may include a questionnaire.

Thus, the commercial may be selected based on various factors including, but not limited to a user profile, demographic information, technical capacity of a system with which the commercial is delivered, preferences of a user, past decisions of a user, movie selection, rating information, available commercials, priority of the commercial, commercial terms associated with the commercial, holiday information, time of the delivery, and length of interaction with a user.

In still yet another embodiment, it may be verified that the commercial has been viewed by a user. Thus, the movie may be conditionally allowed to be viewed, based on the verification. As yet another option, a record may be generated for logging the verification.

In use, a cost of the movie may be partially discounted based on the delivery of the commercial. Alternatively, a cost of the movie may be fully discounted based on the delivery of the commercial. Further, the movie may be viewed promptly after the delivery of the commercial, or after a predetermined amount of time subsequent to the delivery of the commercial.

Another system, method and computer program product are provided for commercial-based payment for pay-per-view movies. In use, a selection of at least one of a plurality of movies is received, utilizing an input device. Thereafter, a commercial is delivered, utilizing an output device. After delivering the commercial, user input is received, utilizing the input device. It may then be verified whether the commercial has been viewed. Thus, the selected at least one movie may be allowed to be viewed utilizing the output device, based on the verification.

Yet another system, method and computer program product are provided for tracking or managing commercial-based payment for pay-per-view movies. To afford the same, a data structure is provided including a plurality of records. Each record includes a user identifier indicative of a user, and a plurality of movie identifiers each associated with the user identifier and indicative of movies selected by the user. Still yet, each record may further include a verification object associated with each movie identifier for verifying that the user viewed a commercial delivered in conjunction with the corresponding movie.

Still yet another system, method and computer program product are provided for tracking or managing commercial-based payment for pay-per-view movies. Again, a plurality of records may be provided each including a user identifier indicative of a user. Still yet, each record may further include a feedback object associated with each user identifier and indicative of feedback of the user provided in response to a commercial delivered in exchange for at least partial payment of a movie.

In use, the foregoing data structure(s) may be used by maintaining the records, processing the records, and even reporting on the processing to an advertiser.

The foregoing systems, methods and computer program products may be further applicable to other types of media beyond movies. For example, in one embodiment, a plurality of media capable of being delivered is displayed, utilizing an output device. Thereafter, a selection of at least one of the media is received, utilizing an input device. In conjunction with the present technique, it is determined whether commercial-based payment is applicable. If it is determined that the commercial-based payment is applicable, a commercial is delivered, utilizing the output device. In use, the selected at least one media is delivered, utilizing the output device.

In one embodiment, the media may include video content, audio content, digital content, live content, pre-recorded content, etc.

### BRIEF DESCRIPTION OF THE DRAWINGS

FIG. 1 illustrates a network architecture, in accordance with one embodiment.

FIG. 2 shows a representative hardware environment that may be associated with the server devices and/or client devices of FIG. 1, in accordance with one embodiment.

FIG. 3 shows a method for commercial-based payment for pay-per-view movies, in accordance with one embodiment.

FIG. 4 illustrates a framework for selecting a commercial, in accordance with another embodiment.

FIG. 5 shows a method for back-end processing to afford commercial-based payment for pay-per-view movies, in accordance with one embodiment.

### DETAILED DESCRIPTION

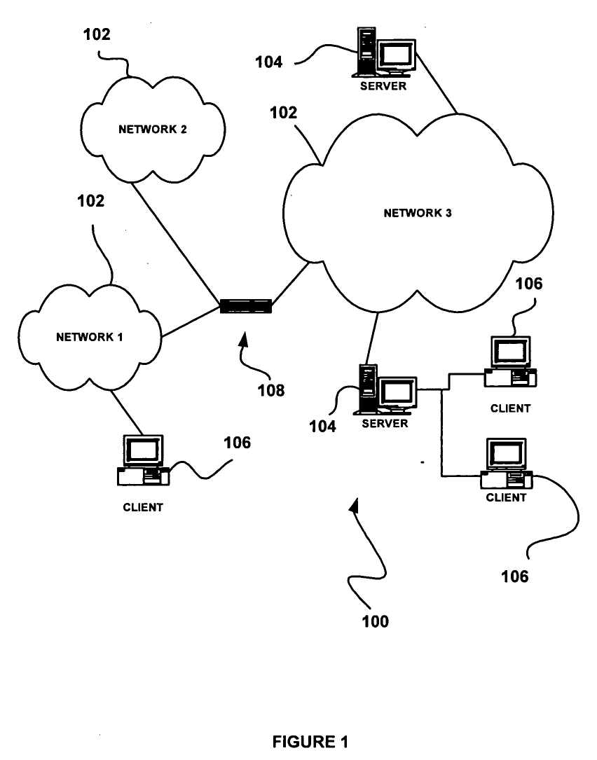

FIG. 1 illustrates a network architecture 100, in accordance with one embodiment. As shown, a plurality of networks 102 is provided. In the context of the present network architecture 100, the networks 102 may each take any form including, but not limited to a local area network (LAN), wireless network (e.g. satellite network, etc.), wide area network (WAN) such as the Internet, cable network (e.g. cable video delivery network, etc.), television network, etc.

Coupled to the networks 102 are server devices 104 which are capable of communicating over the networks 102. Also coupled to the networks 102 and the server devices 104 is a plurality of client devices 106. Such client devices 106 may each include a desktop computer, lap-top computer, hand-held computer, mobile phone, hand-held computer, personal video recorder (PVR), digital set top box, digital media [e.g. compact disc (CD), digital video disc (DVD), MP3, etc.] player, printer, television, and/or any other type of logic. In order to facilitate communication among the networks 102, at least one gateway or router 108 is optionally coupled therebetween.

Further, it should be noted that at least a portion of the foregoing network devices in the present network architecture 100 may be configured for commercial-based payment for pay-per-view media (e.g. movies, television, sports, news, radio, etc.). In one example of use, a plurality of media capable of being viewed is displayed. Thereafter, a selection of at least one of the media is received. In conjunction with the present technique, it is determined whether commercial-based payment is applicable. If it is determined that the commercial-based payment is applicable, a commercial is delivered. In use, the selected at least one media is delivered.

More illustrative information will now be set forth regarding various optional architectures and features with which the foregoing technique which may or may not be implemented, per the desires of the user. It should be strongly noted that the following information is set forth for illustrative purposes and should not be construed as limiting in any manner. Any of the following features may be optionally incorporated with or without the exclusion of other features described.

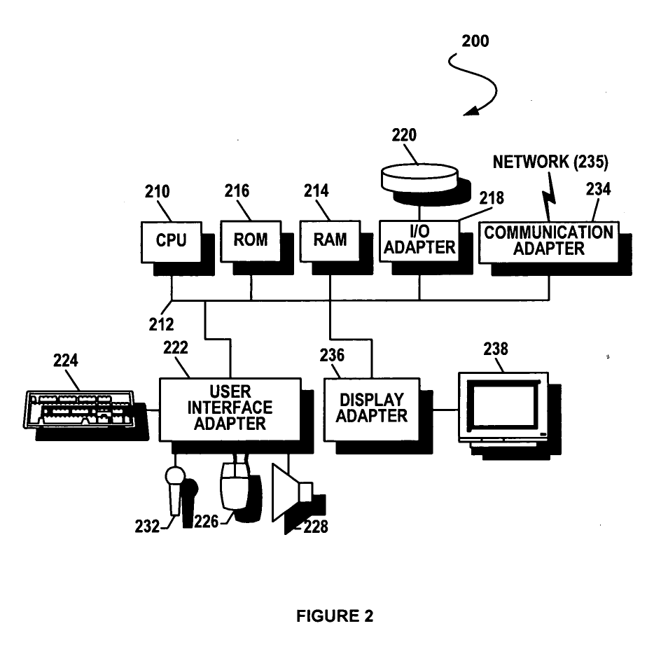

FIG. 2 shows a representative hardware environment that may be associated with the server devices 104 and/or client devices 106 of FIG. 1, in accordance with one embodiment. Such figure illustrates a possible hardware configuration in accordance with one embodiment having a central processing unit 210, such as a microprocessor, and a number of other units interconnected via a system bus 212.

While various other components are shown in FIG. 2, it should be understood that the various depicted components may be omitted, and other components may be incorporated. For example, depending on the nature of the device (e.g. desktop computer, lap-top computer, hand-held computer, mobile phone, hand-held computer, PVR, digital set top box, digital media player, etc.), various components may be added and/or omitted. Still yet, additional instances of the various components (e.g. central processing unit 210, etc.) shown may be provided for redundancy and enhancement purposes, etc.

The device shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown), Wi-Fi (not shown), a remote (not shown), etc. to the bus 212, communication adapter 234 for connecting the workstation to a communication network 235 (e.g., a data processing network) and a display adapter 236 for connecting the bus 212 to a display device 238. While not shown, middleware may further be provided for interfacing the operating system, etc.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, middleware, or any desired combination thereof. For that matter, any type of logic may be utilized which is capable of implementing the various functionality set forth herein.

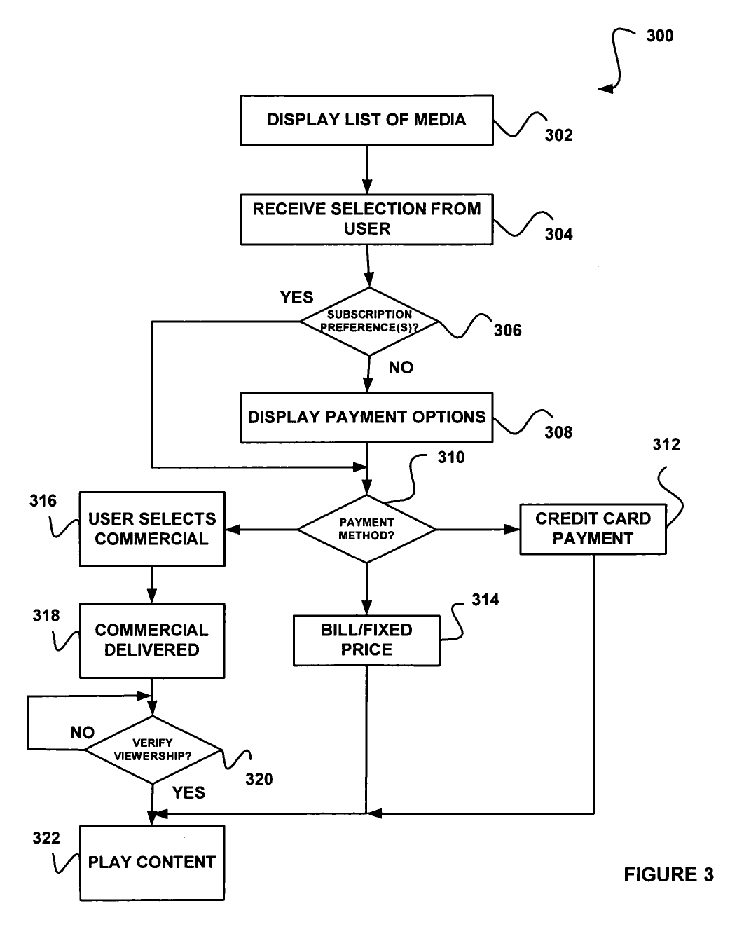

FIG. 3 shows a method 300 for commercial-based payment for pay-per-view movies, in accordance with one embodiment. As an option, the method 300 may be implemented in the context of the architecture and environment of FIGS. 1 and/or 2. Of course, however, the method 300 may be carried out in any desired environment.

Further, while the present method 300 is set forth in the context of pay-per-view movies, it should be noted that any of the following principles may be applicable to absolutely any type of pay-per-view media. Just by way of example, television, sports, news, audio, games, etc. are also contemplated. For that matter, the media may refer to video content, audio content, digital content, live content, pre-recorded content, and/or any other type of content.

Initially, in operation 302, a plurality of movies is displayed, utilizing an output device. In the context of the present description, such output device may include any of the components and/or devices shown in FIGS. 1 and/or 2, or any other mechanism capable of displaying the movies. Further, as an option, the movies may be displayed in a list, representing movies that are available for delivery.

Further, the movies may be displayed in response to any desired initiating event. For example, the available movies may be displayed in response the selection of a particular channel on a television. Still yet, the available movies may be displayed in response to a search in a database initiated by a user (e.g. a search initiated on the Internet utilizing a search engine, etc.). Even still, the movies may be displayed in response to a request received at a web-site (e.g. clicking on an icon, etc.). As yet another option, the display of movies may be initiated by a user responding to a message (e.g. e-mail, etc.) that was received. Of course, the display of the movies may be initiated in any desired manner.

Then, utilizing an input device, selection of at least one of the movies is received. See operation 304. In the context of the present description, such input device may include any of the components and/or devices shown in FIGS. 1 and/or 2, or any other mechanism capable of receiving input from a user at any point in time. While various input/output devices will be referenced hereinafter, it should be noted that such devices may or may not include the same input/output devices referenced with respect to operations 302 and 304.

In conjunction with the present method 300, it is determined whether commercial-based payment is applicable. This may be accomplished in various ways. For example, it may be determined that the commercial-based payment is applicable by querying a database reflecting preferences of a user. See decision 306. Such database may be populated with such preferences at a time prior to the selection of a desired movie. In such database, at least one of the preferences of the user may indicate that the commercial-based payment is requested on an on-going basis. If it is determined that this is the case in decision 306, subsequent payment options may be skipped, as shown in FIG. 3.

If, however, no such preferences exist per decision 306, it may be determined that the commercial-based payment is applicable by prompting a user to choose from a plurality of payment options. In one embodiment, such payment options may be displayed, utilizing an output device for selection, as indicated in operation 308. Such payment options may include, for example, a credit card payment option, a post-billing payment option, a commercial-based payment option, and/or any combination thereof.

Thus, if it is determined that credit card payment is desired per decision 310, credit card payment may be initiated in operation 312. Similarly, if it is determined that post-billing is desired per decision 310, a user may be billed a fixed price at a later time per operation 314. Finally, if it is determined that the commercial-based payment is applicable per decision 310, upon the selection of the commercial-based payment option, the method 300 continues as shown.

To this end, the user selection of commercial-based payment may be initiated at any point in time (e.g. at a time a movie is desired, at a time a subscription is initiated, a time when preferences are input, etc.). Further, while two techniques have been set forth for ascertaining a desire for commercial-based payment, it should be noted that any type of determination may be utilized which is capable of establishing that commercial-based payment is applicable.

Once it is determined that the commercial-based payment is applicable, a plurality of commercial options may be displayed for selection, as noted in operation 316. Such commercial options may allow a user to select a number of commercials and/or commercial types (to be described hereinafter) which are to be delivered. Optionally, a duration of the commercials may shorten as a function of the number of commercials which are to be viewed. Thus, a constant, predetermined duration of commercial viewing is ensured.

As yet another option, the commercial options may allow a user to select among a plurality of commercials. To this end, the user may select to which commercial he/she is to be exposed. Further, the user may select a particular commercial vendor or sponsor, after which only commercials are delivered which are associated with such selected commercial vendor or sponsor.

Next, in operation 318, a commercial is delivered, utilizing an output device. In one embodiment, the commercial may include a passive advertisement or the like. In yet other embodiments, the commercial may require interaction from the user. For example, the commercial may require feedback from the user. To facilitate such interaction, the commercial may optionally be paused, rewound, re-played, etc. To this end, such feedback may be collected and/or monitored for various purposes (e.g. advertisement purposes, advertisement valuation, etc.). For example, subsequent commercials may be delivered based on the interaction, or may be selected based on a user profile.

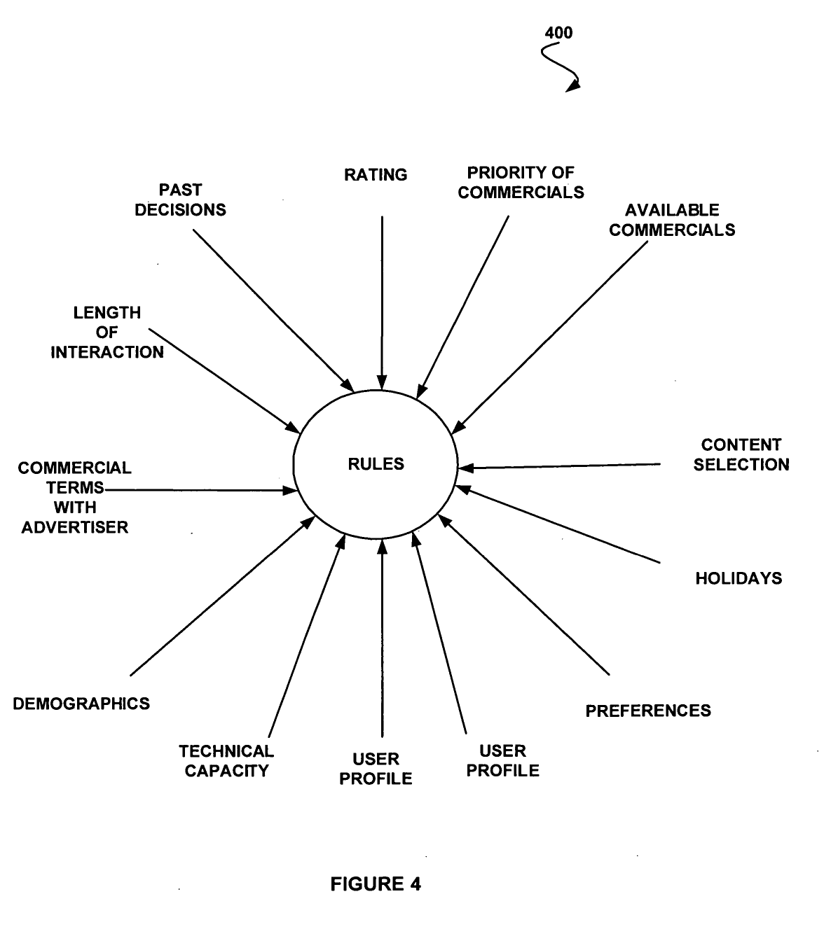

Of course, any desired criteria may be used for commercial selection (more information on such criteria will be set forth hereinafter during reference to FIG. 4). As another option, the commercial may include a questionnaire, survey, etc. Thus, in the context of the present description, the term commercial may refer to any content, other than the selected media (e.g. movie), which has a commercial purpose, at least in part. Further, the term deliver may refer to any transmission, broadcasting, unicasting, streaming, and/or any other technique for delivering the commercial.

In decision 320, it may be verified that the commercial has been viewed by a user. This may be accomplished by receiving answers to questions related to the commercial that confirm that the commercial has been comprehensively viewed. Optionally, such questions may be selected from a random set, etc. Further, if the commercial takes the form of a questionnaire, such verification may be accomplished by verifying receipt of the answers associated with the same. Of course, any technique may be used for verifying that a purpose of the commercial has, at least in part, been achieved.

As a further option, the operations 316-320 may be repeated, as desired. For example, if a user chooses to view three commercials of one minute each, the user may be given a choice of multiple commercials or types and, after delivery, the user may be again given the choice of additional commercials from which to choose.

The selected movie may be conditionally allowed to be viewed in operation 322 utilizing an output device, based on the verification of decision 320. Optionally, the movie may be viewed promptly after the delivery of the commercial, or after a predetermined amount of time subsequent to the delivery of the commercial (e.g. utilizing an issued token, etc.). While it is disclosed that the movie is viewed after the delivery of the commercial, it should be noted that the commercial and/or components thereof may be temporally interspersed during viewing of the movie.

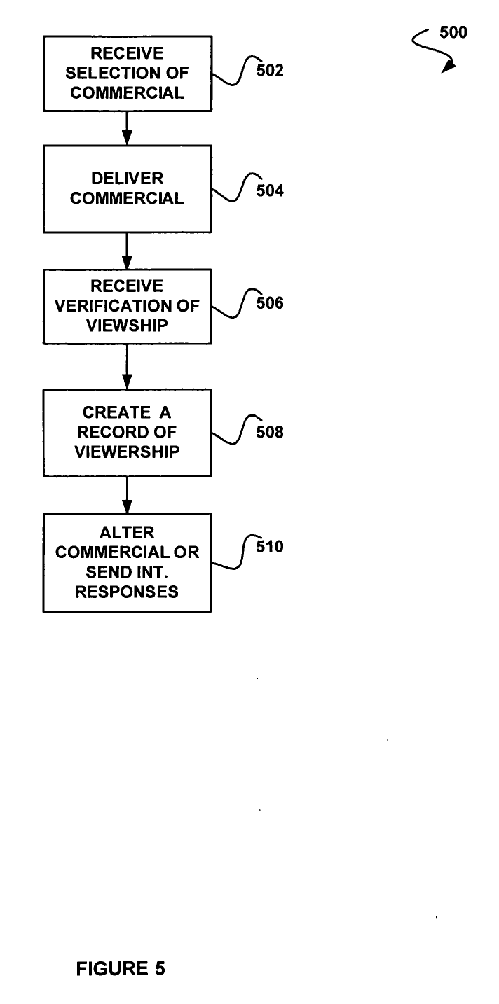

As yet another option, a record may be generated for logging the verification. More information regarding such logging and related back-end processing will be set forth later in greater detail during reference to FIG. 5.

To this end, a cost of the movie may be at least partially discounted based on the delivery of the commercial. For example, a standard discount may be applied to all users during commercial-based payment, or such discount may vary based on various factors relevant to the user and/or interaction during/after the delivery of the commercial (e.g. the user provides different degrees of feedback, the user viewed different durations/amounts of commercials, the user purchases a product in response to the commercial, etc.). Alternatively, a cost of the movie may be fully discounted based on the delivery of the commercial. In any case, the present technique may be implemented in a pre-payment and/or post-payment framework. Thus, an alternative to other types of payment (e.g. billing, etc.) may be made available for pay-per-view systems.

More illustrative information will now be set forth regarding various optional architectures and features with which the foregoing method 300 may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 4 illustrates a framework 400 for selecting a commercial, in accordance with another embodiment. As an option, the exemplary framework 400 may be implemented in the context of the details of FIGS. 1-3. In particular, the present framework 400 may be utilized in the context of commercial delivery in operation 318 of FIG. 3. Of course, however, the exemplary method 400 may be carried out in any desired environment.

As shown, the commercial may be selected as a function of various rules based on factors including, but not limited to a user profile, demographic information, technical capacity of a system with which the commercial is delivered, preferences of a user, past decisions of a user, movie selection, rating information, available commercials, priority of the commercial, commercial terms associated with the commercial, holiday information, time of the delivery, and length of interaction with a user.

FIG. 5 shows a method 500 for back-end processing to afford commercial-based payment for pay-per-view movies, in accordance with one embodiment. As an option, the method 500 may be implemented in the context of the architecture and environment of FIGS. 1-4. For example, the method 500 may be carried out on a server device (e.g. see, for example, the server devices 104 of FIG. 1, etc.), which may, in turn, interact with a client device (e.g. see, for example, the client devices 106 of FIG. 1, etc.), which may be adapted to carry out the method 300 of FIG. 3. Of course, however, the method 500 may be carried out in any desired environment. For instance, any functionality may be implemented client-side and/or server-side, as desired.

As shown, a selection of a commercial is received in operation 502. Thereafter, the selected commercial may be delivered in operation 504. Again, the actual commercial may be selected via any desired algorithm (e.g. see, for example, the rules of FIG. 4, etc.). For example, a database may be queried based on the rules and factors, as desired. It may then be verified that the commercial has been viewed by the user. Note operation 506.

To this end, a record of viewership may be generated. Note operation 508. Table 1 illustrates one possible record data structure. It should be noted that such record is set forth for illustrative purposes only and should not be construed as limiting in any manner.

TABLE 1

| USER | MOVIE | VERIFICATION | FEEDBACK |
|---|---|---|---|
| USER1 | MOVIE1 | | |
| | MOVIE2 | X | FEEDBACK A, B, C, D |
| | MOVIE3 | | |
| | MOVIE4 | X | FEEDBACK E, F, G, H |
| USER2 | MOVE5 | X | FEEDBACK I, J, K |

As shown in Table 1, a data structure is provided including a plurality of records. Each record includes a user identifier indicative of a user, and a plurality of movie identifiers each associated with the user identifier and indicative of movies selected by the user. Still yet, each record may further include a verification object associated with each movie identifier for verifying that the user viewed a commercial delivered in conjunction with the corresponding movie.

Still yet, each record may further include a feedback object associated with each user identifier and indicative of feedback of the user provided in response to a commercial delivered in exchange for at least partial payment of a movie. Thus, such records, or any portion thereof, may be used for tracking or managing commercial-based payment for pay-per-view movies.

In use, the foregoing data structure may be used by maintaining the records, processing the records, and even reporting on the processing (e.g. regarding the verification and/or feedback, etc.) to an advertiser. Such reporting may be used to report how many users viewed a commercial, manage the accounting (e.g. pass on costs associated with the discounting, etc.), etc. Still yet, the reporting may include processed (e.g. aggregated, summarized, etc.) feedback information which may, in turn, be used to optimize the effectiveness of advertisements and maximize revenue, by tailoring the rules which govern how and which commercials are displayed, etc. See operation 510, for example.

While various embodiments have been described above, it should be understood that they have been presented by way of example only, and not limitation. For example, any of the network elements may employ any of the desired functionality set forth hereinabove. Thus, the breadth and scope of a preferred embodiment should not be limited by any of the above-described exemplary embodiments, but should be defined only in accordance with the following claims and their equivalents.

1. A computer-implemented method, comprising:
displaying a plurality of movies, utilizing an output device;
receiving a selection of at least one of the movies, utilizing an input device;
determining whether commercial-based payment is applicable;
if it is determined that the commercial-based payment is applicable, delivering a commercial, utilizing the output device; and
allowing the selected at least one movie to be viewed, utilizing the output device.

2. The method of claim 1, wherein the movies are displayed in a list.

3. The method of claim 1, wherein the movies are displayed in response to a search in a database initiated by a user.

4. The method of claim 1, wherein the movies are displayed in response to a request received at a web-site.

5. The method of claim 1, wherein it is determined that the commercial-based payment is applicable by prompting a user to choose from a plurality of payment options.

6. The method of claim 5, wherein the payment options include a credit card payment option.

7. The method of claim 5, wherein the payment options include a post-billing payment option.

8. The method of claim 5, wherein the payment options include a commercial-based payment option.

9. The method of claim 5, wherein the payment options are displayed for selection.

10. The method of claim 1, wherein it is determined that the commercial-based payment is applicable by querying a database reflecting preferences of a user.

11. The method of claim 10, wherein at least one of the preferences of the user indicates that the commercial-based payment is requested on an on-going basis.

12. The method of claim 1, and further comprising displaying a plurality of commercial options, if it is determined that the commercial payment is applicable.

13. The method of claim 12, wherein the commercial options allow a user to select a number of commercials which are to be delivered.

14. The method of claim 13, wherein a duration of the commercials lengthens as a function of the number of commercials which are to be delivered.

15. The method of claim 12, wherein the commercial options allows a user to select among a plurality of commercials.

16. The method of claim 1, wherein the commercial requires interaction from the user.

17. The method of claim 16, wherein the commercial requires feedback from a user.

18. The method of claim 16, wherein subsequent commercials are delivered based on the interaction.

19. The method of claim 18, wherein the commercial is selected based on a user profile.

20. The method of claim 18, wherein the commercial includes a questionnaire.

21. The method of claim 1, and further comprising verifying that the commercial has been viewed by a user.

22. The method of claim 21, wherein the movie is conditionally allowed to be viewed, based on the verification.

23. The method of claim 22, wherein a record is generated for logging the verification.

24. The method of claim 1, wherein the commercial is selected based on at least one factor selected from the group consisting of a user profile, demographic information, technical capacity of a system with which the commercial is delivered, preferences of a user, past decisions of a user, movie selection, rating information, available commercials, priority of the commercial, commercial terms associated with the commercial, holiday information, time of the delivery, and length of interaction with a user.

25. The method of claim 1, wherein a cost of the movie is partially discounted based on the delivery of the commercial.

26. The method of claim 1, wherein a cost of the movie is fully discounted based on the delivery of the commercial.

27. The method of claim 1, wherein the movie is viewed promptly after the delivery of the commercial.

28. The method of claim 1, wherein the movie is viewed after a predetermined amount of time, after the delivery of the commercial.

29. A computer program product embodied on a computer readable medium, comprising:
computer code for displaying a plurality of movies;
computer code for receiving a selection of at least one of the movies;
computer code for determining whether commercial-based payment is requested;
computer code for delivering a commercial, if it is determined that the commercial-based payment is requested; and
computer code for allowing the selected at least one movie to be viewed.

30. A system, comprising:
a processor for determining whether commercial-based payment is applicable;
an input device in communication with the processor, the input device for receiving a selection of one of a plurality of movies;
an output device in communication with the processor, the output device for delivering a commercial if it is determined that the commercial-based payment is requested, and allowing the selected at least one movie to be viewed.

31. A computer-implemented method, comprising:
receiving a selection of at least one of a plurality of movies, utilizing an input device;
delivering a commercial, utilizing an output device;
receiving user input, after delivering the commercial, utilizing the input device;
verifying whether the commercial has been viewed;
allowing the selected at least one movie to be viewed utilizing the output device, based on the verification.

32. A computer program product embodied on a computer readable medium, comprising:
computer code for receiving a selection of at least one of a plurality of movies;
computer code for delivering a commercial;
computer code for receiving user input, after delivering the commercial;
computer code for verifying whether the commercial has been viewed;
computer code for allowing the selected at least one movie to be viewed, based on the verification.

33. A data structure embodied on a computer readable medium, comprising:
a plurality of records each including:
a user identifier indicative of a user,
a plurality of movie identifiers each associated with the user identifier and indicative of movies selected by the user, and
a verification object associated with each movie identifier for verifying that the user viewed a commercial delivered in conjunction with the corresponding movie.

34. A data structure embodied on a computer readable medium, comprising:
a plurality of records each including:
a user identifier indicative of a user, and
a feedback object associated with each user identifier and indicative of feedback of the user provided in response to a commercial delivered in exchange for at least partial payment of a movie.

35. A computer-implemented method, comprising:
maintaining a plurality of records each including: a user identifier indicative of a user, and a feedback object associated with each user identifier and indicative of feedback of the user provided in response to a commercial delivered in exchange for at least partial payment of a movie;
processing the records; and
reporting on the processing to an advertiser.

36. A computer-implemented method, comprising:
displaying a plurality of media capable of being delivered, utilizing an output device;
receiving a selection of at least one of the media, utilizing an input device;
determining whether commercial-based payment is applicable;
if it is determined that the commercial-based payment is applicable, delivering a commercial, utilizing the output device;
allowing the selected at least one media to be delivered, utilizing the output device.

37. The method of claim 36, wherein the media includes video content.

38. The method of claim 36, wherein the media includes audio content.

39. The method of claim 36, wherein the media includes digital content.

40. The method of claim 36, wherein the media is live content.

41. The method of claim 36, wherein the media is pre-recorded content.

42. The method of claim 36, wherein the media is displayed in a list.

43. The method of claim 36, wherein the media is displayed in response to a search in a database initiated by a user.

44. The method of claim 36, wherein the media is displayed in response to a request received at a web-site.

45. The method of claim 36, wherein it is determined that the commercial-based payment is applicable by prompting a user to choose from a plurality of payment options.

46. The method of claim 45, wherein the payment options include a credit card payment option.

47. The method of claim 45, wherein the payment options include a post-billing payment option.

48. The method of claim 45, wherein the payment options include a commercial-based payment option.

49. The method of claim 45, wherein the payment options are displayed for selection.

50. The method of claim 36, wherein it is determined that the commercial-based payment is applicable by querying a database reflecting preferences of a user.

51. The method of claim 50, wherein at least one of the preferences of the user indicates that the commercial-based payment is requested on an on-going basis.

52. The method of claim 36, and further comprising displaying a plurality of commercial options, if it is determined that the commercial payment is applicable.

53. The method of claim 52, wherein the commercial options allow a user to select a number of commercials which are to be delivered.

54. The method of claim 53, wherein a duration of the commercials lengthens as a function of the number of commercials which are to be delivered.

55. The method of claim 52, wherein the commercial options allows a user to select among a plurality of commercials.

56. The method of claim 36, wherein the commercial requires interaction from the user.

57. The method of claim 56, wherein the commercial requires feedback from a user.

58. The method of claim 56, wherein subsequent commercials are delivered based on the interaction.

59. The method of claim 58, wherein the commercial is selected based on a user profile.

60. The method of claim 58, wherein the commercial includes a questionnaire.

61. The method of claim 36, and further comprising verifying that the commercial has been delivered to a user.

62. The method of claim 61, wherein the media is conditionally allowed to be delivered, based on the verification.

63. The method of claim 62, wherein a record is generated for logging the verification.

64. The method of claim 36, wherein the commercial is selected based on at least one factor selected from the group consisting of a user profile, demographic information, technical capacity of a system with which the commercial is delivered, preferences of a user, past decisions of a user, media selection, rating information, available commercials, priority of the commercial, commercial terms associated with the commercial, holiday information, time of the delivery, and length of interaction with a user.

65. The method of claim 36, wherein a cost of the media is partially discounted based on the delivery of the commercial.

66. The method of claim 36, wherein a cost of the media is fully discounted based on the delivery of the commercial.

67. The method of claim 36, wherein the media is delivered promptly after the delivery of the commercial.

68. The method of claim 36, wherein the media is delivered after a predetermined amount of time, after the delivery of the commercial.
